(19) United States
(12) Patent Application Publication
(10) Pub. No.: US 2006/0168459 A1
(43) Pub. Date: Jul. 27, 2006

(54) Providing data communication between power supply device and powered device in system for supplying power over communication link

(76) Inventors: David McLean Dwelley, Santa Barbara, CA (US); John Arthur Stineman JR., Carpinteria, CA (US)

Correspondence Address: MCDERMOTT WILL & EMERY LLP, 600 13TH STREET, N.W., WASHINGTON, DC, 20005-3096, US

(21) Appl. No.: 11/273,255

(22) Filed: Nov. 15, 2005

Related U.S. Application Data
(60) Provisional application No. 60/646,509, filed on Jan. 25, 2005.

(51) Int. Cl. G06F 1/26

(52) U.S. Cl. 713/300

(57) ABSTRACT

Novel circuitry and methodology for providing data communication between a power supply device and a powered device in a system for supplying power over a communication link. The power supply device, such a device for supplying power over Ethernet, receives from the powered device detection information for detecting the powered device and classification information for determining a power level of the powered device. Information circuitry may be provided for handling information presented by the powered device in addition to the detection and classification information.

This application claims priority of provisional U.S. patent application No. 60/646,509 filed on Jan. 25, 2005, and entitled “SYSTEM AND METHOD FOR SUPPORTING ADVANCED POWER OVER ETHERNET SYSTEM.”

### TECHNICAL FIELD

This disclosure relates to power supply systems, and more particularly, to a circuitry and methodology for providing data communications between a power supply device and a powered device supplied with power over a communication link.

### BACKGROUND ART

Over the years, Ethernet has become the most commonly used method for local area networking. The IEEE 802.3 group, the originator of the Ethernet standard, has developed an extension to the standard, known as IEEE 802.3af, that defines supplying power over Ethernet cabling. The IEEE 802.3af standard defines a Power over Ethernet (PoE) system that involves delivering power over unshielded twisted-pair wiring from Power Sourcing Equipment (PSE) to a Powered Device (PD) located at opposite sides of a link. Traditionally, network devices such as IP phones, wireless LAN access points, personal computers and Web cameras, have required two connections: one to a LAN and another to a power supply system. The PoE system eliminates the need for additional outlets and wiring to supply power to network devices. Instead, power is supplied over Ethernet cabling used for data transmission.

As defined in the IEEE 802.3af standard, PSE and PD are non-data entities allowing network devices to supply and draw power using the same generic cabling as is used for data transmission. A PSE is the equipment electrically specified at the point of the physical connection to the cabling, that provides the power to a link. A PSE is typically associated with an Ethernet switch, router, hub or other network switching equipment or midspan device. A PD is a device that is either drawing power or requesting power. PDs may be associated with such devices as digital IP telephones, wireless network access points, PDA or notebook computer docking stations, cell phone chargers and HVAC thermostats.

PSE's main functions are to search the link for a PD requesting power, optionally classify the PD, supply power to the link if a PD is detected, monitor the power on the link, and disconnect power when it is no longer requested or required. A PD participates in the PD detection procedure by presenting a valid or non-valid detection signature to request power and indicate that power has been received. The PD detection signature has electrical characteristics measured by the PSE.

Traditional data transmission over Ethernet is carried out between the Ethernet twisted pairs in a differential mode, where one pair is used for transmitting data from a first node to a second node, and the other pair is used for receiving data sent from the second node to the first node. In a PoE system, power between a PSE and a PD is transmitted in a common mode as a voltage between two of the Ethernet twisted pairs, typically by powering the center-taps of the isolation transformers used to couple the Ethernet data signals to the wire. Since Ethernet data are sent differentially, the power transmitted in a common mode between the Ethernet transmit pairs and receive pairs does not affect the Ethernet data transmitted in a differential mode.

Although PSE and PD are non-data entities, which are not involved in transmission of Ethernet data, it may be desirable to communicate information between the PSE and the PD. For example, it may be desirable for a PD to request a level of power greater than the power level allowed by the original IEEE 802.3af specification that gives a PD an option of presenting a classification signature to the PSE to indicate how much power it will draw when powered up. A PD may be classified as class 0 to class 4. A PD of class 1 requires that the PSE supplies at least 4.0 W, a PD of class 2 requires that the PSE supplies at least 7.0 W, and a PD of class 0, 3 or 4 requires at least 15.4 W. Based on the determined class of the PD, the PSE applies the required power to the PD.

Currently, a PD has no ability to communicate with a PSE beyond this classification protocol. Therefore, there is a need for a communication scheme to support an information exchange between the PSE and the PD.

### SUMMARY OF THE DISCLOSURE

The present disclosure offers novel circuitry and methodology for providing data communication between a power supply device and a powered device in a system for supplying power over a communication link.

In accordance with one aspect of the disclosure, the power supply device, such as a device for supplying power over Ethernet, receives from the powered device detection information for detecting the powered device and classification information for determining a power level of the powered device. Information circuitry may be provided for handling information presented by the powered device in addition to the detection and classification information. The additional information may be presented after the power is supplied from the power supply device to the powered device or before the power is provided.

The power supply device may comprise detection circuitry for detecting an event associated with presenting the additional information from the powered device. In particular, the detection circuitry may detect a predefined electrical parameter of the powered device corresponding to the additional information.

In accordance with an embodiment of the present disclosure, the detection circuitry may detect a predefined amount of current drawn by the powered device in response to a predefined event and/or for a predefined time period to present the additional information.

For example, the powered device may be configured to draw the predefined amount of current in response to applying power from the power supply device.

The power supply device may comprise an acknowledgement event generator for producing an acknowledgement event to acknowledge receipt of the additional information presented by the powered device. The power supply device may modify a power supply signal applied to the powered device to create the acknowledgement event.

In accordance with an embodiment of the disclosure, a power supply voltage applied to the powered device may be reduced to a predefined level for a predefined period of time to acknowledge receipt of the additional information.

The detection circuitry may detect a further event corresponding to the additional information presented by the powered device after the acknowledgement event is produced. This further event may be accompanied by an attention event created by the powered device before presenting the additional information. An attention event detector may be provided in the power supply device for detecting the attention event.

In accordance with an embodiment of the disclosure, the attention event detector may detect an overcurrent condition corresponding to the attention event.

The power supply device may be configured for presenting information to the powered device. For example, the power supply device may reduce a power supply voltage applied to the powered device to a predefined level for a predefined time period to present information to the powered device.

In accordance with another aspect of the disclosure, a powered device for receiving power supplied from a power supply device over Ethernet may be configured for providing the power supply device with information presented in addition to the detection and classification information.

The powered device may have a source of information configured to present a prescribed electrical parameter as the additional information.

In accordance with an embodiment of the disclosure, the source of information may enable the powered device to draw a predefined amount of current for a predefined time period. The predefined amount of current may be drawn in response to supplying power from the power supply device.

An attention event generator may be provided in the powered device for providing the power supply device with an attention event before presenting the additional information.

In accordance with a further aspect of the disclosure, a power supply device in a PoE system is configured for receiving from the powered device detection information for detecting the powered device and classification information for determining a power level of the powered device in accordance with IEEE 802.3af standard. Information circuitry is provided for handling additional information presented by the powered device in addition to the detection and classification information in accordance with the IEEE 802.3af standard.

In particular, the information circuitry may obtain a power requirement information from the PD.

In accordance with a method of the present disclosure, the following steps are carried out:

detecting a powered device coupled to the communication link,

detecting a power requirement of the detected powered device,

providing power to the powered device and

detecting information presented by the powered device after the power requirement is detected.

In accordance with a further aspect of the disclosure, a local area network (LAN) comprises a plurality of nodes, a network hub and communication cabling connecting the nodes to the network hub for providing data communications. The network hub includes a power supply device for supplying power over the communication cabling to a load. The power supply device is configured for detecting information presented by the load in addition to information relating to detecting the load and detecting a power requirement of the load.

Additional advantages and aspects of the disclosure will become readily apparent to those skilled in the art from the following detailed description, wherein embodiments of the present disclosure are shown and described, simply by way of illustration of the best mode contemplated for practicing the present disclosure. As will be described, the disclosure is capable of other and different embodiments, and its several details are susceptible of modification in various obvious respects, all without departing from the spirit of the disclosure. Accordingly, the drawings and description are to be regarded as illustrative in nature, and not as limitative.

### BRIEF DESCRIPTION OF THE DRAWINGS

The following detailed description of the embodiments of the present disclosure can best be understood when read in conjunction with the following drawings, in which the features are not necessarily drawn to scale but rather are drawn as to best illustrate the pertinent features, wherein:

FIG. 1 is a diagram illustrating a Power over Ethernet system of the present disclosure.

FIG. 2 is a diagram illustrating an exemplary arrangement of circuitry for supporting data communications between power sourcing equipment and a powered device.

FIG. 3 is a flow chart illustrating an exemplary procedure for carrying out data communications between the power sourcing equipment and the powered device.

### DETAILED DISCLOSURE OF THE EMBODIMENTS

The present disclosure will be made using the example of a Power over Ethernet (PoE) system. It will become apparent, however, that the concepts described herein are applicable to any system for supplying power over a communication link. For example, the system of the present disclosure may be utilized for providing communications between a power supply device and a load in a local area network (LAN) having a plurality of nodes, a network hub and communication cabling connecting the nodes to the network hub for providing data communications. The network hub may include the power supply device, and the communication cabling may be utilized for supplying power from the power supply device to the load.

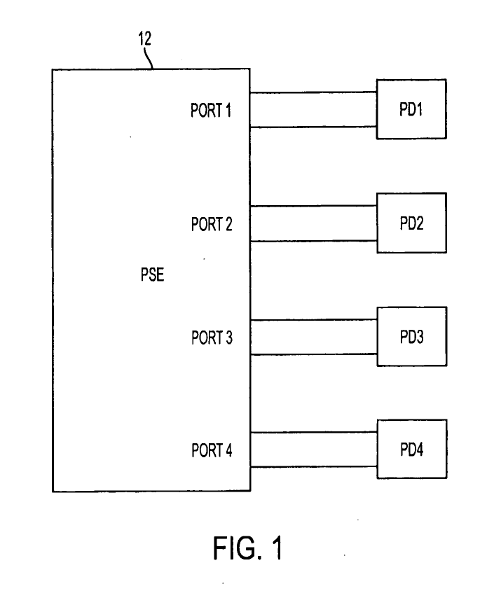

FIG. 1 shows a simplified block-diagram illustrating a PoE system 10 including Power Sourcing Equipment (PSE) 12 having multiple ports 1 to 4 connectable to Powered Devices (PD) 1 to 4 via respective links, each of which may be provided using 2 or 4 sets of twisted pairs within the Ethernet cable. Although FIG. 1 shows four ports of the PSE 12, one skilled in the art would realize that any number of ports may be provided.

The PSE 12 may interact with each PD in accordance with the IEEE 802.3af standard. In particular, the PSE 12 and the PD participate in the PD detection procedure, during which the PSE 12 probes a link to detect the PD. If the PD is detected, the PSE 12 checks the PD detection signature to determine whether it is valid or non-valid. The valid and non-valid detection signatures are defined in the IEEE 802.3af standard. While the valid PD detection signature indicates that the PD is in a state where it will accept power, the non-valid PD detection signature indicates that the PD is in a state where it will not accept power.

If the signature is valid, the PD has an option of presenting a classification signature to the PSE to indicate how much power it will draw when powered up. For example, a PD may be classified as class 0 to class 4. A PD of class 1 requires that the PSE supplies at least 4.0 W, a PD of class 2 requires that the PSE supplies at least 7.0 W, and a PD of class 0, 3 or 4 requires at least 15.4 W. Based on the determined class of the PD, the PSE applies the required power to the PD.

PSE and PD are non-data entities, which are not involved in transmission of Ethernet data. However, it may be desirable to communicate information between the PSE and the PD. For example, a PD may need to request a special operating power level different from the standard IEEE 802.3af levels, or a power supply system may involve transmitting to a PSE a system serial number that uniquely identifies the PD.

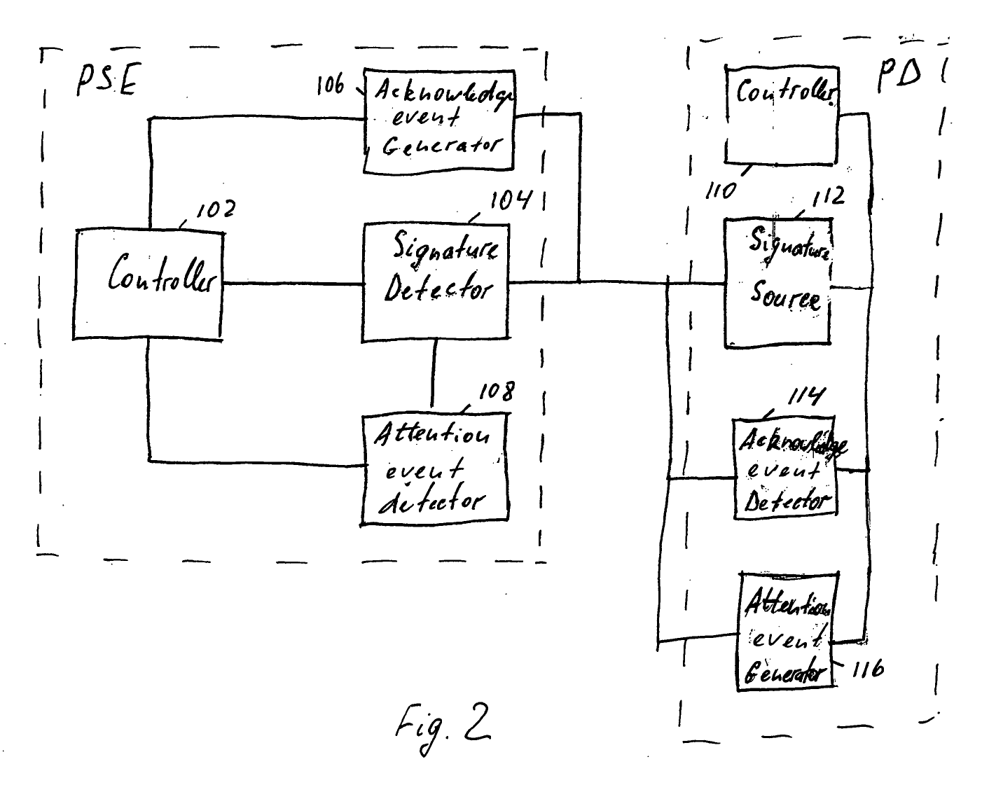

In accordance with an exemplary embodiment of the present disclosure, the PoE system 10 may utilize a predefined third signature presented by a PD after detection and classification signatures for conveying additional information from the respective PD to the PSE 12. In particular, as shown in FIG. 2, the PSE 12 may include a controller 102 for controlling PSE operations supporting a data exchange with the PD, a signature detector 104 for detecting a predefined signature used for conveying PD information presented to the PSE, an acknowledgement event generator 106 for producing an event acknowledging the receipt of the PD signature, and an attention event detector 108 for detecting an attention event produced by the PD to direct the attention of the PSE 12 to a signature presented thereafter.

A PD capable of presenting the third signature to the PSE 12 may include a controller 110 for controlling PD operations supporting a data exchange with the PSE 12, a signature source 112 that originates a predefined signature used for presenting information to the PSE 12, an acknowledgement event detector 114 for detecting the acknowledgement event produced by the PSE 12, and an attention event generator 116 for producing the attention event detectable by the PSE 12. One skilled in the art would realize that the elements of the PSE and PD shown in FIG. 2 are presented only to illustrate the concept of the present disclosure and may be implemented in a number of different ways.

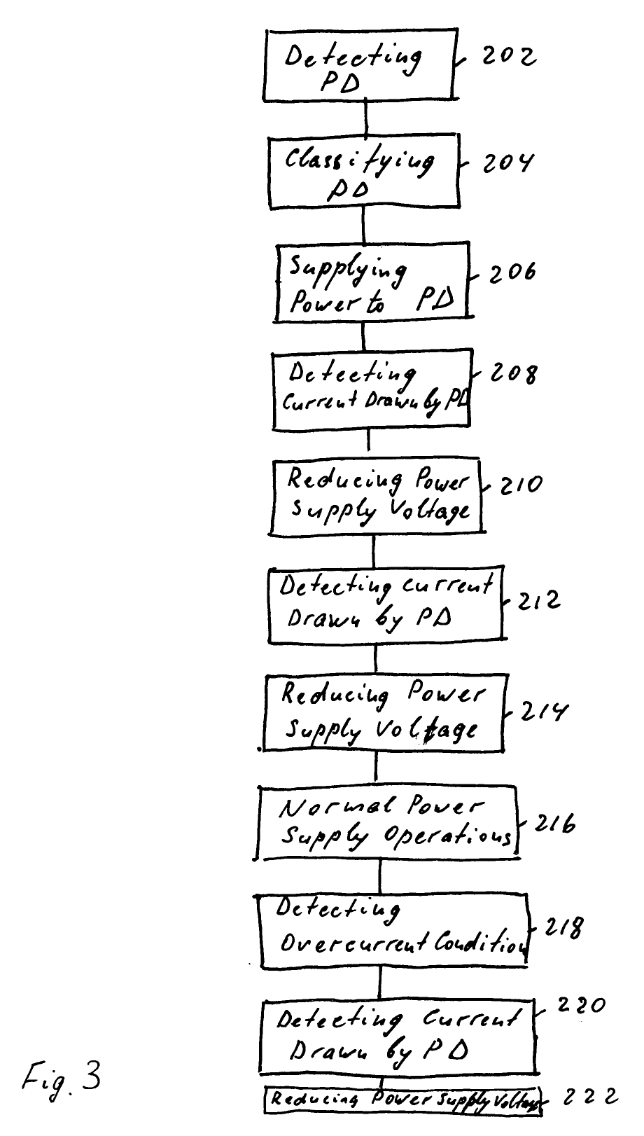

Referencing to FIG. 3 that illustrates data exchange operations in accordance with an exemplary embodiment of the present disclosure, the PSE 12 may probe a PoE link to detect a PD connected to that link (block 202). If the PD is detected, the PSE 12 checks the PD detection signature to determine whether it is valid or non-valid. If the signature is valid, the PD may present a classification signature to indicate how much power it will draw when powered up. The PD may present a signature corresponding to any one of classes 0 to 4, which any PSE would recognize. For example, a class 4 signature may be presented. The PSE performs a classification procedure to detect the classification signature and determine to which class the PD belongs (block 204). The detection and classification procedures may be performed in accordance with the IEEE 802.3af specification.

Thereafter, the PSE 12 may apply a 48V power supply voltage to the PD to provide it with the requested power (block 206). In response to the power supply voltage, the PD may present the third signature in any way that carries information that the PD wants to communicate to the PSE. This information may request, for example, a special operating power level different from the standard IEEE 802.3af levels, or present a system serial number that uniquely identifies the PD. The third signature may be produced by the signature source 112 of the PD and detected by the signature detector 104 of the PSE. Although the present disclosure describes that the third signature is presented in response to supplying power to the PD, one skilled in the art would realize that the third signature may be presented before power is applied to the PD or after a certain period of time after power is provided.

In accordance with an exemplary embodiment of the disclosure, when the PD is provided with a 48V power supply voltage, the signature source 112 presents the third signature by drawing a predefined amount of current for a predefined time period, e.g., for 100 ms. The amount of the drawn current may represent a particular information to be presented. For example, the signature source 112 may include a current source controlled by the controller 110 to draw the predefined current for a predefined time period. Alternatively, the third signature may be presented by a PD as a particular resistance, voltage, or a power load for a defined period of time and/or in response to a defined electrical stimulus. Also, the third signature may be applied as a data stream transmitted on a common-mode or a differential-mode channel of the PoE system.

The third signature may consist of a single piece or bit of information or may include multiple pieces or bits created by modulating the respective parameter of the PD. For example, the amount of current drawn by the PD may be modulated to represent multiple bits of information.

The third signature is detected by a PSE designed to recognize additional information represented by the third signature (block 208). The signature detector 104 of the PSE may be configured to detect any PD's characteristic utilized as the third signature. For example, the signature detector 104 may include a current sensor and a timer for detecting the predefined current drawn by the PD for the predefined period of time. The signature detector 104 may be controlled by the controller 102 to observe current drawn when a 48V power supply voltage is applied by the PSE.

The signature detector 104 may utilize a regular current sensing mechanism of a PSE that includes a sense resistor connected in series to a power line. Any impedance circuitry, e.g. a diode circuit, may be utilized instead of the sense resistor.

If the signature detector 104 detects the predefined signature, it may send a respective signal to the controller 102 that decodes the information represented by the third signature. Alternatively, the controller 102 may analyze the current measured by the signature detector 104 to determine whether the third signature is received and to decode the presented information.

When the third signature is detected, the controller 102 may control the acknowledgement event generator 106 to produce a predefined acknowledgement event confirming the receipt of information from the PD. Also, the acknowledgement event may be used by the controller to accept or deny a request made by the PD. The acknowledgement event may be any event recognizable by the PD. For example, the acknowledgement event generator 106 may reduce a 48V power supply voltage applied by the PSE to a lower level for a predefined time period and then restore the power supply voltage to a full 48V level (block 210). For instance, to acknowledge the receipt of information from the PD, the 48V power supply voltage may be reduced to a level lower than 30V for 10 ms.

Alternatively, an acknowledgement event may be produced using any other characteristic of the PSE, for example, by interrupting or modifying power supplied to the PD for a predefined period of time or by altering the timing of the power supply. Also, an acknowledgement event may be made by sending a data stream back to the PD either via a common-mode or a differential-mode channel of the PoE system.

If a predefined third signature is not detected by the PSE, it assumes that a conventional, 802.3af standard complying PD is connected to its port. Therefore, the PSE will continue operations prescribed by the 802.3af standard.

The acknowledgement event may be detected by the acknowledgement event detector 114 of the PD capable of recognizing a predefined acknowledgement event. For example, the acknowledgement event detector 114 may include a voltage detector and a timer to detect the reduction of power supply voltage to a predefined level for a predefined time period.

If a predefined acknowledgement event is not detected by the PD, it may repeat the third signature after a predetermined time period. If no acknowledgement is still received, the PD may assume that the PSE is not able to recognize the predefined signature. Therefore, the PD will continue operations prescribed by the 802.3af standard.

Based on the acknowledgement event or its absense, the PD may provide a communication to the end user, for example, to indicate that the PD is capable to modify its behavior. This communication may be carried out as a visual or audio feedback to the user, or a data transmission to the host system.

In response to the acknowledgement event, the PD may initiate another data communication session with the PSE, for example, to present another piece of information or to provide robustness of the data communication system. The data communication session may be handled in the same manner as the initial session or in a different manner. For example, the PD may draw a predefined amount of current for a predefined time period (block 212), where the amount of current may represent the information being presented. Alternatively, the information may be presented as another predefined characteristic of the PD, such as a particular resistance, voltage, or a power load; or as a data stream transmitted to the PSE via a common-mode or differential-mode channel of the PoE.

The PSE may respond to the presented information by providing an acknowledgement event, for example, by reducing a power supply voltage to a predefined level for a predefined period of time (block 214).

During a normal power supply operation (block 216), when a requested power is supplied from the PSE to the PD, the PD is still may be able to communicate information to the PSE. For example, if the PD changes its power requirement, it may present the respective request to the PSE.

To direct the PSE's attention to the information to be presented, the attention event generator 116 of the PD may produce an attention event detectable by the PSE. For example, the PD may create a short-term overcurrent condition by drawing an amount of power exceeding an allowed limit for a short period of time, e.g. for 10 ms.

The attention event detector 108 of the PSE may detect the attention event and indicate to the controller 102 that new information is going to be presented by the PD (block 218). For example, the attention event detector 108 may be triggered by the current sensing mechanism of the PSE when the overload current is detected. The attention event detector 108 may use a timer to determine the duration of the detected overcurrent condition. If the duration of the overcurrent condition corresponds to the time period defined for attention events, the attention event detector 108 indicates that the overcurrent condition represents the attention event to be followed by information presented by the PD. The overcurrent condition does not exceed the overload time limit established by the IEEE 802.3af standard, to prevent the PSE from removing power in response to the overcurrent condition.

After presenting the attention event, the PD may present new information to the PSE, for example, by drawing a predefined amount of current for a predefined time period. When the PSE detects new information (block 220), it may produce an acknowledgement event to acknowledge the receipt of the new information, for example, by reducing a power supply voltage to a predefined level for a predefined time period (block 222). This data exchange may be repeated every time when the PD needs to present information to the PSE.

Similarly, during a normal power supply operation, the PSE may be able to communicate to the PD. For example, the PSE may request the PD to limit its power consumption when the amount of power available from the PSE is limited. When more power becomes available, the PSE may suggest the PD to return to a higher power consumption mode.

The PSE may present its information to the PD by modifying any of its parameters. For example, it may reduce a power supply voltage to a predefined level for a predefined amount of time. The reduced level of the power supply voltage may represent the information being presented. The PD may acknowledge the receipt of the information from the PSE by modifying any of its parameters. For example, the PD may produce an acknowledgement event by drawing a predefined amount of current for a predefined time period.

The foregoing description illustrates and describes aspects of the present invention. Additionally, the disclosure shows and describes only preferred embodiments, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art.

For example, the present disclosure discloses presenting information by a PD in response to a power supply voltage from a PSE after the detection and classification procedures are completed. However, the PD's information may be presented before the PSE applies a power supply voltage to the PD. In particular, the PD may present information by modifying its detection and/or classification signatures defined by the IEEE 802.3af standard so as to keep these signatures valid. For example, the PD may perform time and/or amplitude modulation of the class current presented during the classification interval so as to maintain the class current within the valid range for the respective class. For instance, an IEEE 802.3af-compliant class 3 PD must maintain a current between 26 mA and 30 mA for the duration of the class test. Therefore, the PD may rapidly switch the current between, for example, 27 mA and 29 mA to present additional information to the PSE capable of recognizing this information. In this case, the PS will remain a valid IEEE 802.3af-compliant class 3 PD.

The embodiments described hereinabove are further intended to explain best modes known of practicing the invention and to enable others skilled in the art to utilize the invention in such, or other, embodiments and with the various modifications required by the particular applications or uses of the invention.

Accordingly, the description is not intended to limit the invention to the form disclosed herein. Also, it is intended that the appended claims be construed to include alternative embodiments.

What is claimed is:

1. A system for supplying power over a communication link, comprising:
a power supply device for providing power to a powered device via the communication link, said power supply device being configured for receiving from the powered device detection information for detecting the powered device and classification information for determining a power level of the powered device, and
information circuitry for handling additional information presented by the powered device in addition to the detection and classification information.

2. The system of claim 1, wherein the information circuitry is configured for handling the additional information after the power is supplied from the power supply device to the powered device.

3. The system of claim 1, wherein the power supply device is configured for providing power to the powered device over Ethernet.

4. The system of claim 1, wherein the power supply device comprises detection circuitry for detecting an event associated with presenting the additional information from the powered device.

5. The system of claim 4, wherein the detection circuitry is configured to detect a predefined electrical parameter of the powered device corresponding to the additional information.

6. The system of claim 5, wherein the detection circuitry is configured to detect a predefined amount of current drawn by the powered device to present the additional information.

7. The system of claim 6, wherein the predefined amount of current is drawn by the powered device in response to providing power from the power supply device to the powered device.

8. The system of claim 4, wherein the power supply device comprises an acknowledgement event generator for producing an acknowledgement event to acknowledge receipt of the additional information presented by the powered device.

9. The system of claim 8, wherein the power supply device is configured to modify a power supply signal applied to the powered device to acknowledge receipt of the additional information.

10. The system of claim 9, wherein the power supply device is configured to reduce a power supply voltage applied to the powered device to acknowledge receipt of the additional information.

11. The system of claim 8, wherein the detection circuitry is configured for detecting a further event corresponding to the additional information presented by the powered device after the acknowledgement event is produced.

12. The system of claim 1, wherein the power supply device comprises an attention event detector for detecting an attention event provided by the powered device before presenting the additional information.

13. The system of claim 12, wherein the attention event detector is configured to detect an overcurrent condition corresponding to the attention event.

14. A power supply device for providing power to a powered device over Ethernet, comprising information detection circuitry for detecting information presented by the powered device after supplying power to the powered device.

15. The device of claim 14, wherein the detection circuitry is configured for detecting a predefined amount of current drawn by the powered device to present the additional information.

16. The device of claim 15, wherein the predefined amount of current is drawn by the powered device in response to supplying power to the powered device.

17. The device of claim 14, wherein the power supply device further comprising circuitry for presenting information to the powered device.

18. A powered device for receiving power supplied from a power supply device over Ethernet, the powered device is configured for providing the power supply device with additional information presented in addition to detection and classification information according to IEEE 802.3af standard.

19. The device of claim 18, comprising a source of information configured to present a prescribed electrical parameter as the additional information.

20. The device of claim 19, wherein the source of information is configured to draw a predefined amount of current.

21. The device of claim 20, wherein the predefined amount of current is drawn in response to supplying power from the power supply device.

22. The device of claim 19, further comprising an attention event generator for providing the power supply device with an attention event before presenting the additional information.

23. A method of supplying power over a communication link, comprising the steps of:
detecting a powered device coupled to the communication link,
detecting a power requirement of the detected powered device,
providing power to the powered device and
detecting information presented by the powered device after the power requirement is detected.

24. The method of claim 23, wherein the information is presented by the powered device after the power is provided.

25. The method of claim 23, wherein the step of detecting information comprises detecting a predefined electrical characteristic of the powered device.

26. The method of claim 25, wherein the step of detecting information comprises detecting a predefined amount of current drawn by the powered device.

27. The method of claim 23, further comprising the step of acknowledging the detected information.

28. The method of claim 23, further comprising the step of detecting an attention event provided by the powered device before presenting the information.

29. The method of claim 28, wherein the attention event includes an overcurrent condition provided for a predefined period of time.

30. A local area network (LAN) comprising:
a plurality of nodes,
a network hub and
communication cabling connecting the nodes to the network hub for providing data communications;
the network hub including a power supply device for supplying power over the communication cabling to a load;
the power supply device being configured for detecting information presented by the load in addition to information relating to detecting the load and detecting a power requirement of the load.

31. A Power over Ethernet (PoE) system comprising:
a power supply device for providing power to a powered device, said power supply device being configured for receiving from the powered device detection information for detecting the powered device and classification information for determining a power level of the powered device in accordance with IEEE 802.3af standard, and
information circuitry for handling additional information presented by the powered device in addition to the detection and classification information provided in accordance with the IEEE 802.3af standard.

32. The PoE system of claim 31, wherein the information circuitry is configured for obtaining power requirement information from the PD.
